(19) United States
(12) Patent Application Publication
(10) Pub. No.: US 2005/0283348 A1
(43) Pub. Date: Dec. 22, 2005

(54) Serviceability framework for an autonomic data centre

(75) Inventors: Alex Kwok Kee Tsui, Markham (CA); Paul Ming Chen, Markham (CA); Nicholas George Kocsis, Scarborough (CA)

Correspondence Address: International Business Machines;Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/870,225

(22) Filed: Jun. 17, 2004

(51) Int. Cl. G06F 17/50

(52) U.S. Cl. 703/13

(57) ABSTRACT

There is provided a data processing system-implemented method, system and an article of manufacture for providing a serviceability framework for autonomic resource management in a computer data centre. The data centre is monitored based on a logical representation (model) in the serviceability framework representative of the actual physical devices. The data centre logical model is constantly synchronized with the physical devices of the actual data centre where inconsistencies occur, and fast reporting is required before more problems occur. Monitoring agents associated with all the data centre devices are implemented to quickly identify and deal with problems before human intervention is required. A data centre health monitor is capable of detecting the malfunctions of typical devices and sub-systems in the data centre. For problems or failures that require drastic steps, the subsystem may be isolated and then interrogated separately from the rest of the data centre. Interruptions may be avoided by cloning a designated portion of the data centre systems for off-line trouble-shooting, thereby saving the systems from shutting down totally. A robust set of messages and trace logs including current operational status and health of the data centre may be provided for further diagnostic problem determination.

### FIELD OF THE INVENTION

This present invention relates generally to resource management of a computer data centre and more specifically to a serviceability framework for autonomic resource management in a computer data centre.

### BACKGROUND OF THE INVENTION

An autonomic data centre is the data centre that has the capability for self-management, typically with minimal human intervention. With the advent of automated data centre management software, such as, the IBM® Tivoli® Intelligent Think Dynamic Orchestrator, autonomic data centres are fast becoming a reality. In many data centres one of the crucial aspects of the data centre operations is the serviceability of the data centre management system. If any one of the devices contained within the data centre breaks down, all or part of the data centre operations may be jeopardized. Within the traditional typical data centre administration systems or network management systems, there is a significant reliance on manual intervention to manage and control the underlying data centre equipment. Typically when failures occur, the trouble-shooting and diagnostic work is primarily performed on the spot by human operators. This process is usually slow, inefficient and prone to errors and inconsistencies.

It would therefore be highly desirable to have methods and software allowing for a more effective means to control and manage a data centre.

### SUMMARY OF THE INVENTION

Conveniently, software exemplary of an embodiment of the present invention enhances an autonomic data centre, where the amount of servicing of resources is usually less than a conventional data centre since most of the operations are automatic. Operational knowledge is combined into an automated process typically removing much of the guesswork from operations management. Therefore, the serviceability of the autonomic data centre management systems should provide more efficient, effective problem determination facilities, enabling a small number of servicing resources to be leveraged to maintain the data centre with minimal disruptions to operations when malfunctions occur. As the business grows, IT organizations are expected to be responsive to the evolving business needs for quicker turnaround times and with minimal manpower and cost placing more emphasis on automated processes.

The proposed serviceability framework provides the capability of maintaining data centres on a broad scale, but it is especially suitable for autonomic data centres where a minimum of service personnel are available and fast turnaround time for servicing is required. Essentially, the data centre is monitored based on a logical representation (model) in a serviceability framework representative of the actual physical devices. The data centre logical model is constantly synchronized with the physical devices of the actual data centre where inconsistencies occur, and fast reporting is required before more problems occur. Monitoring agents associated with all the data centre devices are implemented to quickly identify and deal with problems before human intervention is required. A data centre health monitor is capable of detecting the malfunctions of typical devices and sub-systems in the data centre. For problems or failures that require drastic steps, the subsystem may be isolated and then interrogated separately from the rest of the data centre. Interruptions may be avoided by cloning a designated portion of the data centre systems for off-line trouble-shooting, thereby saving the systems from shutting down totally. A robust set of messages and trace logs including current operational status and health of the data centre may be provided for further diagnostic problem determination.

The proposed serviceability framework is designed to enable an autonomic data centre with the necessary processes to maintain and administer the data centre with minimal intervention. With minimal human intervention, the day-to-day operations of the autonomic data centre and the serviceability framework may then allow the information technology organization to concentrate on other areas of improvements and cost reduction. Implementation of the serviceability framework typically provides fast, efficient identification of the malfunctioning areas of the data centre enabling automatic adjustment and recovery. This system recovery, problem determination and notification capability, typically allows information technology personnel to more easily pin-point the cause of the malfunction which may then require less time to resolve. Off-line trouble-shooting capabilities offered by the data centre logical model clone and data centre simulator, provide a capability in which problems may be proactively identified and solutions more fully tested before being introduced into the production environment.

In one embodiment of the present invention there is provided a data processing system-implemented method for providing a serviceability framework for autonomic resource management in a computer data centre, comprising: generating a logical model representative of the computer data centre; synchronizing the logical model periodically with the computer data centre; monitoring devices of the computer data centre for predefined conditions; informing a data centre operations system of the computer data centre of the predefined conditions; selectively communicating requests from the data centre operations system to respective devices having predefined conditions to update the devices; logging computer data centre activity in a runtime log; and selectively executing the data centre model clone in a data centre simulator.

In another embodiment of the present invention there is provided a data processing system for providing a serviceability framework for autonomic resource management in a computer data centre, the data processing system comprising: a means for generating a logical model representative of the computer data centre; a means for synchronizing the logical model periodically with the computer data centre; a means for monitoring devices of the computer data centre for predefined conditions; a means for informing a data centre operations system of the computer data centre of the predefined conditions; a means for selectively communicating requests from the data centre operations system to respective devices having predefined conditions to update the devices; a means for logging computer data centre activity in a runtime log; and a means for selectively executing the data centre model clone in a data centre simulator.

In another embodiment of the present invention there is provided an article of manufacture for directing a data processing system to provide a serviceability framework for autonomic resource management in a computer data centre, the article of manufacture comprising: a program usable medium embodying one or more instructions executable by the data processing system, the one or more instructions comprising: data processing system executable instructions for generating a logical model representative of the computer data centre; data processing system executable instructions for synchronizing the logical model periodically with the computer data centre; data processing system executable instructions for monitoring devices of the computer data centre for predefined conditions; data processing system executable instructions for informing a data centre operations system of the computer data centre of the predefined conditions; data processing system executable instructions for selectively communicating requests from the data centre operations system to respective devices having predefined conditions to update the devices; data processing system executable instructions for logging computer data centre activity in a runtime log; and data processing system executable instructions for selectively executing the data centre model clone in a data centre simulator.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate embodiments of the present invention by example only,

FIG. 1 is a block diagram of a computer system in which may be implemented an embodiment of the present invention;

FIG. 2 is a block diagram of components of an embodiment of the present invention as supported in the system of FIG. 1; and

FIG. 3 is a flow diagram of activity among the components of the embodiment of FIG. 2.

Like reference numerals refer to corresponding components and steps throughout the drawings.

### DETAILED DESCRIPTION

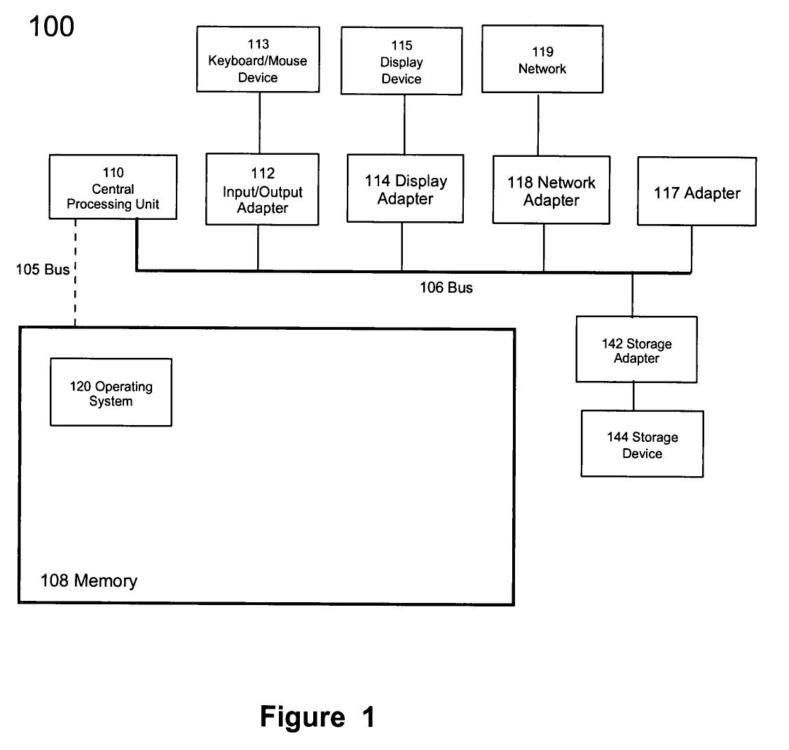

FIG. 1 depicts, in a simplified block diagram, a computer system 100 suitable for implementing embodiments of the present invention. Computer system 100 has a central processing unit (CPU) 110, which is a programmable processor for executing programmed instructions, such as instructions implementing components of the serviceability framework stored in memory 108. Memory 108 can also include hard disk, tape or other storage media. While a single CPU is depicted in FIG. 1, it is understood that other forms of computer systems can be used to implement the invention, including multiple CPUs. It is also appreciated that the present invention can be implemented in a distributed computing environment having a plurality of computers communicating via a suitable network 119, such as the Internet.

CPU 110 is connected to memory 108 either through a dedicated system bus 105 and/or a general system bus 106. Memory 108 can be a random access semiconductor memory for storing components of the serviceability framework described later. Memory 108 is depicted conceptually as a single monolithic entity but it is well known that memory 108 can be arranged in a hierarchy of caches and other memory devices. FIG. 1 illustrates that operating system 120, may reside in memory 108.

Operating system 120 provides functions such as device interfaces, memory management, multiple task management, and the like as known in the art. CPU 110 can be suitably programmed to read, load, and execute instructions of operating system 120. Computer system 100 has the necessary subsystems and functional components to implement support for the serviceability framework as will be discussed later. Other programs (not shown) include server software applications in which network adapter 118 interacts with the server software application to enable computer system 100 to function as a network server via network 119.

General system bus 106 supports transfer of data, commands, and other information between various subsystems of computer system 100. While shown in simplified form as a single bus, bus 106 can be structured as multiple buses arranged in hierarchical form. Display adapter 114 supports video display device 115, which is a cathode-ray tube display or a display based upon other suitable display technology that may be used to depict test results provided by portions of the serviceability framework. The Input/output adapter 112 supports devices suited for input and output, such as keyboard or mouse device 113, and a disk drive unit (not shown). Storage adapter 142 supports one or more data storage devices 144, which could include a magnetic hard disk drive or CD-ROM drive although other types of data storage devices can be used, including removable media for storing import, export files, logging data and other information in support of the serviceability framework.

Adapter 117 is used for operationally connecting many types of peripheral computing devices to computer system 100 via bus 106, such as printers, bus adapters, and other computers using one or more protocols including Token Ring, LAN connections, as known in the art. Network adapter 118 provides a physical interface to a suitable network 119, such as the Internet. Network adapter 118 includes a modem that can be connected to a telephone line for accessing network 119. Computer system 100 can be connected to another network server via a local area network using an appropriate network protocol and the network server can in turn be connected to the Internet. FIG. 1 is intended as an exemplary representation of computer system 100 by which embodiments of the present invention can be implemented. It is understood that in other computer systems, many variations in system configuration are possible in addition to those mentioned here.

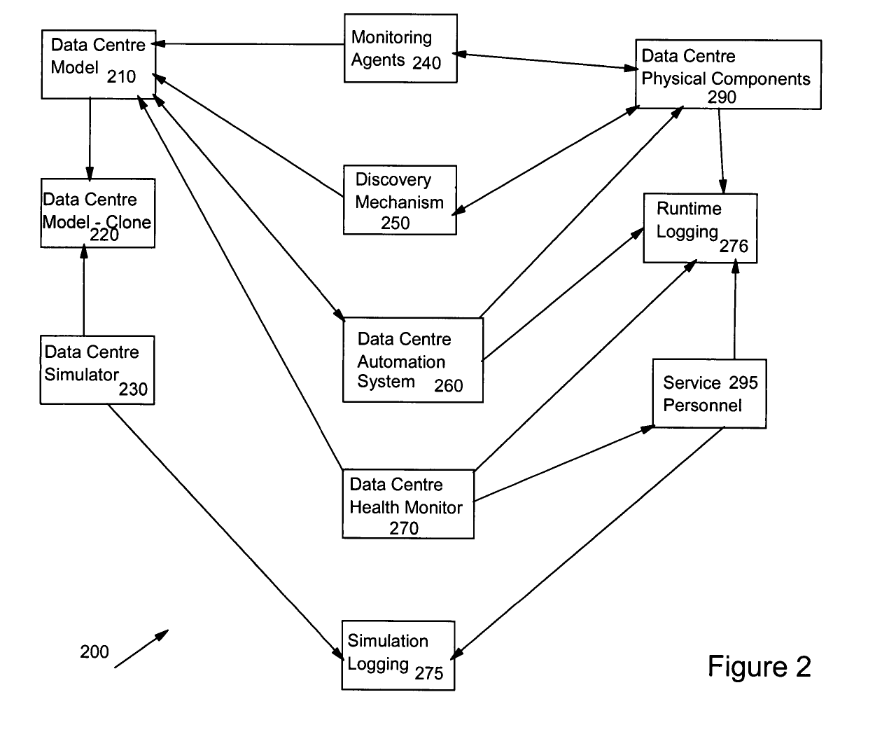

FIG. 2 illustrates in block form the components of a serviceability framework for an autonomic data centre as may be found in an embodiment of the present invention. The proposed serviceability framework for autonomic data centre includes a logical representation (model) as Data centre model 210 making reference to all the devices and resources in the data centre. The model registers the attributes and states of the data centre devices and the relationship among those devices.

An export facility to take a snap shot of the data centre logical model and output it into archival format and an import facility to replicate the data centre logical model using the output from the export facility are provided. These functions are provided to move data between Data centre model 210 and Data centre model clone 220. This capability is useful for further analysis offsite from the data centre.

Data centre simulator 230 is provided to simulate typical operations of a data centre using Data centre model clone 220. Data centre clone 120 may also be used to prepare replicated images of components for subsequent use.

Monitoring agents 240 are installed on each data centre component of Data centre physical devices 290 to synchronize the device status with that of representations in Data centre model 210.

Discovery mechanism 250 is provided to periodically determine existence of new equipment recently added to Data centre physical devices 290. Discovery may be performed by frequent polling of the devices or other means whether they be manual or automatic so as to acquire the data. The mechanism provides update on any new components found to Data centre model 210 keeping it up to date.

Data centre health monitor 270 is used to track the health (operational status) of each device, data centre sub-system, and management software, of the data centre and to report on any malfunctioning device or issue an alarm. Data centre health monitor 270 may query Data centre model 210 for status information on the various components. In some cases there may be notification messages related to current device situations sent to Service personnel 295 from Data centre health monitor 270. Examples of such notification would be for events requiring operator intervention as in loading tapes, supplies or for equipment not yet supported by more full automation scripts.

A robust set of messages and trace logs of Runtime logging 276 and Simulation logging 275 are used to record activities of Data centre physical devices 290 and Data centre simulator 230 respectively.

Data centre automation system 260 is the centralized node for inquiring and updating Data centre model 210 as well as controlling activity in data centre physical components 290. Log data created by Data centre automation system 260 is also sent to Runtime logging 276 where it is collected for further analysis as required. Log data may be used to restore component s of Data centre physical components 290 of Data centre model 210. Reports generated by Data centre health monitor 270 may also be reviewed within Data centre automation system 260.

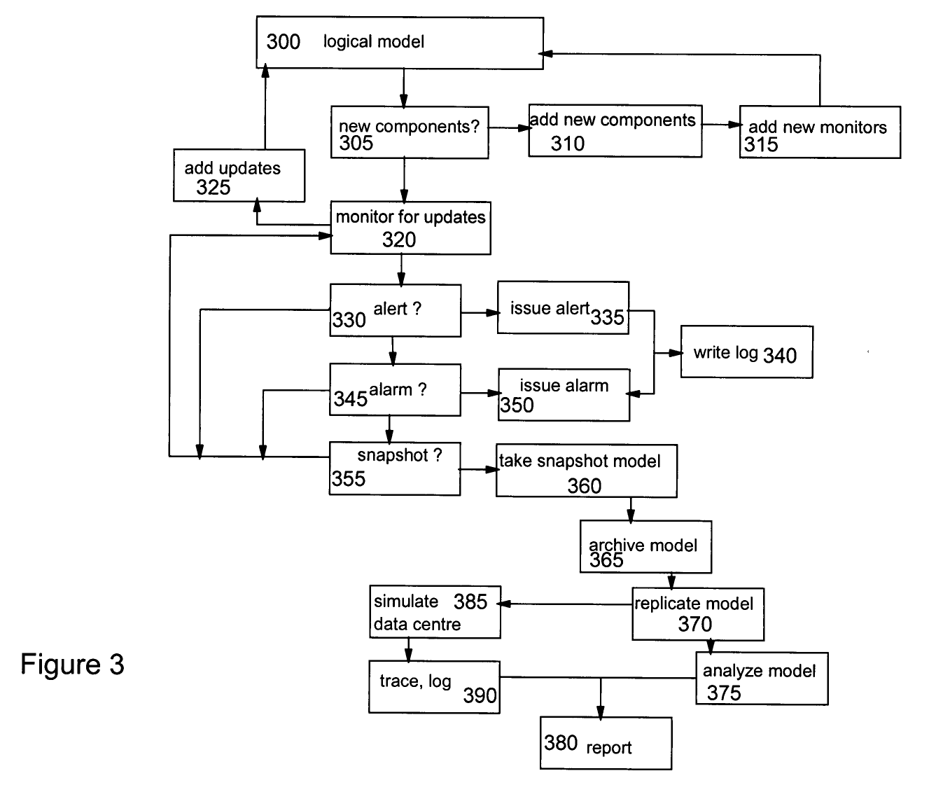

FIG. 3 is a flow diagram showing the logical flow of information representative of the working of an embodiment of the present invention shown in FIG. 2. Beginning with logical model 300 (representation of Data centre model 210 of FIG. 2 previously described) processing moves to operation 305 in which a determination is made regarding new components in the data centre (data centre physical components 290 of FIG. 2).

If new components are found they are added to the logical model during operation 310 while additional monitoring facilities are also added during operation 315. If on the other hand no new components are discovered, processing continues to operation 320. During operation 320 the various components are monitored for changes in status wherein such status changes being passed through operation 325 update the logical model 300. Logical model 300 now reflects the reality of the physical data centre.

If no updates were required, processing would have moved to operation 330 during which alerts are determined. Having determined the existence of an alert during operation 330 the alert would then be issued during operation 335 and IT personnel would be notified along with information being written to a log during operation 340. If there were not alerts processing would have moved to operation 345.

During operation 345 checking is performed for alarms. If an alarm was raised processing would have moved to operation 350 during which the alarm would have been issued and IT personnel would be notified. In addition the information related to the issued alarm would also have been noted in a log during operation 340 as before. The logs created during operation 340 can then be reviewed and processed at a later time as required or convenient.

If no alarm had been detected processing would have moved to operation 355 during which is determined the need to take a snapshot of the logical model useful for problem analysis. A snapshot is used to save a specific instance of the data centre logical model for later processing. If no snapshot is required processing would have moved to operation 320 to again monitor the complex for updates as before.

If a snapshot was desired processing would have moved to operation 360 in which the request would be performed. Having taken the snapshot an archive of the data centre model is created in operation 365. This archived model may then be used during operation 370 to create a replica of the data centre model for subsequent processing. Analysis of the replica is performed during operation 375 with the subsequent production of a report in operation 380. The report of operation 380 can be filtered to focus on specific areas of interest within the collection of data centre components. Typical filtering may include views by device type, application, cluster of devices, network components or other views as required for management information or problem analysis.

In addition from the replicated model of operation 370 there is a capability in operation 385 to produce a simulation of the data centre as reflected in the snapshot of operation 360. Such simulation is useful for determining interactions occurring within the data centre model. Simulation work performed during operation 385 is captured through traces and logging of operation 390. As before information produced during the simulations is also collected, for later analysis, during the logging activity of operation 390. Reports are also created during report operation 380 as described previously.

The serviceability framework helps in servicing of autonomic data centres in a number of useful instances. The proposed serviceability framework serves a serviceability aspect of trouble-shooting the failure of individual devices in the autonomic data centre. With the help of Monitoring agents 240 installed for each device in the autonomic data centre (data centre physical components 190), the operational status of the devices are reflected in real-time within Data centre model 210. Data centre health monitor 270 periodically interrogates Data centre model 210 to determine the health condition of the devices. A malfunction of a device will cause an alarm to be raised and reported to data centre automation system 260 for appropriate action. The monitoring process may be configurable, such that, activities chosen to be ignored can be performed without raising alarms. A problem causing an alarm will also be logged in runtime logging 276. Data centre health monitor 270 also determines when service personnel 210 are to be informed to take further action on the malfunctioning device by referring to a set of predefined rules for monitored devices. In this way, an activity that is within acceptable levels can be logged while allowing monitoring to continue. Runtime logging 276 records all specified error messages from Data centre physical devices 290, Data centre health monitor 270 and data centre automation system 260, which may then be analyzed later by the service personnel 295 as required.

Trouble-shooting the failure of sub-systems or composite modules of the autonomic data centre is aided by the fact that the correct functioning sub-system or composite module, such as, a cluster or a spare pool in the autonomic data centre is also monitored by Data centre health monitor 270 together with data centre automation system 260. For instance, a failure in deploying a server from a spare pool to a cluster does not trigger any failure signal of any physical devices, but the cluster to which the server is being deployed does not receive the service from the deployed server, and hence does not produce the expected throughput. This event is considered as a malfunction of the cluster. Data centre health monitor 270 would have determined this malfunction and logged the error in runtime logging 276. Data centre health monitor 270 would have also reported the malfunction to data centre automation system 260 that may then trigger recovery action on the cluster. Data centre health monitor 270 determines whether the problem is severe enough to notify service personnel 210 through establishment of thresholds or type of problem to be handled by personnel only. Runtime logging 276 records all specified error messages from Data centre physical devices 290, Data centre health monitor 270 and data centre automation system 260, which may then be analyzed later by the service personnel 210 as required for post problem diagnosis.

Trouble-shooting malfunctions of data centre automation system 260 may be performed with help from data centre health monitor 270. Data centre health monitor 270 is responsible for monitoring the “pulse” as well as other vital operations of data centre automation system 260. A malfunction of data centre automation system 260 is typically considered a severe error requiring service personnel 295 to be notified immediately. Error messages generated from the system will be recorded in runtime logging 276 and may then be analyzed by service personnel 295 to aid in the diagnosis of the related problem.

Managing new device additions and system update or upgrade is also assisted by the framework. When a new device is planned for addition to the autonomic data centre, the device operations and behaviour can be emulated within data centre simulator 230. By taking a snap shot of the current Data centre model 210 using the export facility, the up-to-date Data centre model 210 can be put into data centre simulator 230 for testing. The addition of the new device can then be acted upon within Data centre model clone 220 of the Data centre model 210 and its operations and behaviour can be fully tested to safeguard the proper operation of the new device when introduced in combination with other Data centre physical devices 290 equipment. Problems encountered during the simulation can be diagnosed with data captured in simulation logging 275 as generated by trials in data centre simulator 230.

A key feature of Data centre simulator 230 is that it can inherit from the real data centre as embodied in Data centre model 210 all of the thresholds and levels, that over time, have been incorporated. New devices belong to different sub-groups of devices and a device in a sub-group can inherit attributes from the real data centre devices. This capability allows Data centre simulator 230 to be adaptive based on experience data from Data centre physical devices 290 and Data centre model 210. Such adaptation enhances the likelihood of ensuring that that problems already solved do not appear with the introduction of new devices.

Upgrades or updates of the physical devices as well as the monitoring and automation systems of the data centre can be tested using Data centre model clone 220 in conjunction with data centre simulator 230. This capability minimizes the downtime of upgrading and updating the equipment and systems in the data centre by allowing the process to be more fully tested in the simulated environment thereby reducing the chance of failure.

Off-line trouble-shooting of system problems may also be performed in the environment provided by the framework. Some of the problems in the operation of an autonomic data centre may not be easily diagnosed as most of the devices placed into production cannot be easily unhooked for service. When trouble-shooting other problems such as network configurations or device deployment operations which require the shutdown of portions of the data centre or its sub-systems, the shutdown may be totally avoided or minimized by exporting Data centre model 210 to create Data centre model clone 220 by importing into Data centre simulator 230 simulation environment. The problem may then be reproduced in Data centre simulator 230 and trouble-shooting can be carried out in the simulation environment instead of in the live system.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

1. A data processing system-implemented method for providing a serviceability framework for autonomic resource management in a computer data centre, comprising:
generating a logical model representative of the computer data centre;
synchronizing the logical model periodically with the computer data centre;
monitoring devices of the computer data centre for predefined conditions;
informing a data centre operations system of the computer data centre of the predefined conditions;
selectively communicating requests from the data centre operations system to respective devices having predefined conditions to update the devices;
logging computer data centre activity in a runtime log; and
selectively executing the data centre model clone in a data centre simulator.

2. The data processing system-implemented method for providing the serviceability framework of claim 1 wherein generating the logical model further comprises:
archiving a portion of the logical model;
exporting the portion as a data centre snapshot;
importing the data centre snapshot to create the data centre model clone.

3. The data processing system-implemented method for providing the serviceability framework of claim 1 wherein executing the data centre model clone in a data centre simulator further comprises:
logging results of the execution to a simulation log; and
generating a report.

4. The data processing system-implemented method for providing the serviceability framework of claim 1 wherein monitoring further comprises:
discovering additional devices;
adding monitoring capabilities to each discovered device; and
synchronizing the logical model with information representative of the additional devices.

5. The data processing system-implemented method for providing the serviceability framework of claim 1 wherein monitoring further comprises:
responsive to at least one of an alert and an alarm, issuing the at least one of the alert and the alarm to the data centre operations system; and
selectively issuing the at least one of the alert and the alarm to a service personnel.

6. The data processing system-implemented method for providing the serviceability framework of claim 1 wherein the monitoring is configurable to allow activities to be ignored thereby not producing one of an alert and an alarm.

7. A data processing system for providing a serviceability framework for autonomic resource management in a computer data centre, the data processing system comprising:
a means for generating a logical model representative of the computer data centre;
a means for synchronizing the logical model periodically with the computer data centre;
a means for monitoring devices of the computer data centre for predefined conditions;
a means for informing a data centre operations system of the computer data centre of the predefined conditions;
a means for selectively communicating requests from the data centre operations system to respective devices having predefined conditions to update the devices;
a means for logging computer data centre activity in a runtime log; and
a means for selectively executing the data centre model clone in a data centre simulator.

8. The data processing system for providing the serviceability framework of claim 7 wherein the means for generating the logical model further comprises:
a means for archiving a portion of the logical model;
a means for exporting the portion as a data centre snapshot;
a means for importing the data centre snapshot to create the data centre model clone.

9. The data processing system for providing the serviceability framework of claim 7 wherein executing the data centre model clone in a data centre simulator further comprises:
a means for logging results of the execution to a simulation log; and
a means for generating a report.

10. The data processing system for providing the serviceability framework of claim 7 wherein the means for monitoring further comprises:
a means for discovering additional devices;
a means for adding monitoring capabilities to each discovered device; and
a means for synchronizing the logical model with information representative of the additional devices.

11. The data processing system for providing the serviceability framework of claim 7 wherein the means for monitoring further comprises:
responsive to at least one of an alert and an alarm, means for issuing the at least one of the alert and the alarm to the data centre operations system; and
means for selectively issuing the at least one of the alert and the alarm to a service personnel.

12. The data processing system for providing the serviceability framework of claim 7 wherein the means for monitoring is configurable to allow activities to be ignored thereby not producing one of an alert and an alarm.

13. An article of manufacture for directing a data processing system to provide a serviceability framework for autonomic resource management in a computer data centre, the article of manufacture comprising:
a program usable medium embodying one or more instructions executable by the data processing system, the one or more instructions comprising:
data processing system executable instructions for generating a logical model representative of the computer data centre;
data processing system executable instructions for synchronizing the logical model periodically with the computer data centre;
data processing system executable instructions for monitoring devices of the computer data centre for predefined conditions;
data processing system executable instructions for informing a data centre operations system of the computer data centre of the predefined conditions;
data processing system executable instructions for selectively communicating requests from the data centre operations system to respective devices having predefined conditions to update the devices;
data processing system executable instructions for logging computer data centre activity in a runtime log; and
data processing system executable instructions for selectively executing the data centre model clone in a data centre simulator.

14. The article of manufacture for directing a data processing system to provide a serviceability framework of claim 13 wherein the data processing system executable instructions for generating the logical model further comprises:
data processing system executable instructions for archiving a portion of the logical model;
data processing system executable instructions for exporting the portion as a data centre snapshot;
data processing system executable instructions for importing the data centre snapshot to create the data centre model clone.

15. The article of manufacture for directing a data processing system to provide a serviceability framework of claim 13 wherein executing the data centre model clone in a data centre simulator further comprises:
data processing system executable instructions for logging results of the execution to a simulation log; and
data processing system executable instructions for generating a report.

16. The article of manufacture for directing a data processing system to provide a serviceability framework of claim 13 wherein the data processing system executable instructions for monitoring further comprises:
data processing system executable instructions for discovering additional devices;
data processing system executable instructions for adding monitoring capabilities to each discovered device; and
data processing system executable instructions for synchronizing the logical model with information representative of the additional devices.

17. The article of manufacture for directing a data processing system to provide a serviceability framework of claim 13 wherein the data processing system executable instructions for monitoring further comprises:
responsive to at least one of an alert and an alarm, data processing system executable instructions for issuing the at least one of the alert and the alarm to the data centre operations system; and
data processing system executable instructions for selectively issuing the at least one of the alert and the alarm to a service personnel.

18. The article of manufacture for directing a data processing system to provide a serviceability framework of claim 13 wherein the data processing system executable instructions for monitoring is configurable to allow activities to be ignored thereby not producing one of an alert and an alarm.
